(19) United States
(12) Patent Application Publication
(10) Pub. No.: US 2016/0321677 A1
(43) Pub. Date: Nov. 3, 2016

(54) METHODS AND SYSTEMS FOR PRODUCT AUTHENTICITY VERIFICATION

(71) Applicant: PATRICK DOBAJ, CARLSBAD SPRINGS (CA)

(72) Inventor: PATRICK DOBAJ, CARLSBAD SPRINGS (CA)

(21) Appl. No.: 15/143,818

(22) Filed: May 2, 2016

Related U.S. Application Data
(60) Provisional application No. 62/155,555, filed on May 1, 2015.

(51) Int. Cl. G06Q 30/00; G06F 17/30

(52) U.S. Cl. CPC G06Q 30/0185; G06F 17/30876

(57) ABSTRACT

Consumer purchasing is increasingly being performed online and at the same time internationally so that consumers in one country can purchase directly other countries through online resources and have their purchases shipped directly. Accordingly, distributing counterfeit products becomes easier, especially if the consumer may never have seen, touched, tasted or experienced the original authentic product to recognise a counterfeit. In other instances, consumers know because they pay a fraction of the legitimate version's price. It would be beneficial to provide manufacturers with a means of labelling their products uniquely such that the consumer and/or retailer is able to verify the authenticity of the product quickly and automatically through a portable electronic device or point-of-sale terminal, for example. Further, it would be beneficial for the provisioning of such unique codes to support one-time use, traceability of authentic products and consumer registration to support subsequent sale of their authenticated product.

### CROSS-REFERENCE TO RELATED APPLICATIONS

This patent application claims the benefit of U.S. Provisional Patent Application 62/155,555 filed May 1, 2015 entitled “Methods and Systems for Product Authenticity Verification”, the entire contents of which are incorporated herein by reference.

### FIELD OF THE INVENTION

This invention relates to counterfeiting and more particularly to the verification of a product as authentic.

### BACKGROUND OF THE INVENTION

To counterfeit means to imitate something. Counterfeit products are fake replicas of the real product and are often produced with the intent to take advantage of an aspect of the imitated product such as its superior value, reputation, or brand recognition for example. The word counterfeit frequently describes both the forgeries of currency and documents, as well as the imitations of clothing, handbags, shoes, pharmaceuticals, aviation and automobile parts, watches, electronics (both parts and finished products), software, works of art, toys, movies etc.

In many instances the counterfeit product leaves the consumer with an inferior quality product, perhaps not even working at all in the instances of electronics, spare parts, etc., but generally one exploiting fake company logos and brands. However, in other instances the lower quality product may be harmful to the consumer by containing toxic elements, such as lead in paint on children toys, or failing to give the consumer what they need, such as ceasing to take essential compounds where the fake product is a supplement, infant food, pharmaceutical etc.

As consumer purchasing increasingly becomes virtual through online retailer websites, online marketplaces, and online “auctions” then the introduction of counterfeit products to the consumer becomes easier as it is shipped and delivered directly to them where in many instances they have never seen, touched, tasted or experienced the original authentic product. Accordingly, the ability to market and sell counterfeit products is becoming easier from the old days of market stalls, the “friend of a friend,” visiting countries with counterfeiting cultures, etc. Even when a consumer purchases a product directly from the retailer in a physical store the opportunity to pass through counterfeit product exists with the complicity of retailer employees.

At the same time the global manufacturing basis over the past 50 years has evolved from companies owning manufacturing to their outsourcing on a global basis. As the outsourcing has gone from developed to less well developed countries the opportunities for corruption, fraud, etc. to enter the manufacturing process have increased. The International Chamber of Commerce (ICC) estimated that the counterfeit goods market in 2008 was $650 billion and that the costs of lost tax revenue and additional welfare spending were $125 billion in developed countries alone. The impact on employment was estimated to be the loss of 2.5 million jobs. By 2015, this counterfeit goods market is expected to exceed $1,700 billion or just over 2% of the world's total current economic output.

Accordingly, it would be beneficial to provide manufacturers with a means of labelling their products uniquely such that the consumer and/or retailer is able to verify the authenticity of the product quickly and automatically either through their own portable electronic device, for example, or through a point-of-sale terminal, for example. Further, it would be beneficial for the provisioning of such unique codes to support traceability of authentic products globally as well as consumer registration so that they can subsequently sell their authenticated product.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to counterfeiting and more particularly to the verification of a product as authentic.

In accordance with an embodiment of the invention there is provided a method comprising:
generating a unique product identity comprising:
   receiving a first request at a server from a manufacturer for a set of B unique identities for attachment to a batch of products, the request identifying at least the manufacturer, product related data, and the batch size B;
   generating at the server a set of B unique codes according to a predetermined standard;
   generating at the server the set of B unique identities, each unique product identity formatted according to a predetermined first machine readable format and incorporating at least one of the unique codes;
   transmitting the set of B unique identities to the manufacturer for marking the batch of products; and
   storing the data relating to the request within a database such that the database comprises product identification data relating to valid requests; and
receiving a verification request comprising:
   receiving a second request at the server from a remote electronic device connected to the server via a network, wherein the remote electronic device incorporates at least a microprocessor and a reader supporting at least the predetermined first machine readable format and the request includes a code read from a product by the reader;
   determining whether the code received includes a product identity matching a unique product identity stored within the database; and
   in dependence upon at least the determination sending a response to the remote electronic device.

In accordance with an embodiment of the invention there is provided a method of
verifying the authenticity of a product comprising:
receiving secure requests from manufacturer identifying first products to be manufactured,
providing the manufacturers with first machine readable codes for attachment to the first products, each the first machine readable code comprising at least a unique identity and stored within a database upon issuance;
receiving a request to verify the authenticity of a second product incorporating at least a scanned second machine readable code attached to the second product;
comparing a code within the second machine readable code with the first machine readable codes within the database;
determining whether to send a first message or a second message in dependence upon the comparison, wherein
   the first message comprises at least an indication that the second product has failed authenticity verification; and
   the second message comprises at least an indication that the second product has passed authenticity verification and an identity of the product relating to the matched unique product identity.

In accordance with an embodiment of the invention there is provided a method of verifying the authenticity of a product comprising providing a machine readable code at least one of as part of or attached to a product, the machine readable code encoding at least a unique identity issued by a verification authority allowing subsequent authenticity verification to be performed by scanning and transmitting the machine readable code to the verification authority, wherein the unique identity is not associated with any aspect of the product and its manufacturer except that it was generated next in sequence by a unique identity generator forming part of the verification authority in response to a request for a batch of machine readable codes from the manufacturer.

In accordance with an embodiment of the invention there is provided a label comprising a first part containing at least a machine readable code encoding at least a unique identity issued by a verification authority allowing subsequent authenticity verification to be performed by scanning and transmitting the machine readable code to the verification authority, wherein the unique identity is not associated with any aspect of the product and its manufacturer except that it was generated next in sequence by a unique identity generator forming part of the verification authority in response to a request for a batch of machine readable codes from the manufacturer.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts examples of prior an product labelling;

FIG. 4 depicts a simplified exemplary flow for a product from a manufacturer to a consumer according to an embodiment of the invention;

FIG. 5 depicts an exemplary process flow for a product from manufacture to shipping according to an embodiment of the invention;

FIG. 6 depicts an exemplary process flow for a product from shipper to consumer according to an embodiment of the invention;

FIG. 7 depicts exemplary message flows between a manufacturer and a Unique Labelling Systems/Applications/Platforms (ULSAPs) according to an embodiment of the invention;

FIG. 8 depicts exemplary message flows between a national shipper and a Unique Labelling Systems/Applications/Platforms (ULSAPs) according to an embodiment of the invention;

FIG. 9 depicts exemplary message flows between an international shipper and a Unique Labelling Systems/Applications/Platforms (ULSAPs) according to an embodiment of the invention;

FIG. 10 depicts exemplary message flows between Customs and a Unique Labelling Systems/Applications/Platforms (ULSAPs) according to an embodiment of the invention;

FIG. 11 depicts exemplary message flows between a national shipper and a Unique Labelling Systems/Applications/Platforms (ULSAPs) according to an embodiment of the invention;

FIG. 12 depicts exemplary message flows between a retailer and a Unique Labelling Systems/Applications/Platforms (ULSAPs) according to an embodiment of the invention;

FIG. 13 depicts exemplary message flows between a consumer and a Unique Labelling Systems/Applications/Platforms (ULSAPs) according to an embodiment of the invention;

FIG. 14 depicts exemplary screenshots of a ULSAP upon a user's PED during verification of a product within a store.

### DETAILED DESCRIPTION

The present invention is directed to ratings and more particularly to counterfeiting and more particularly to the verification of a product as authentic.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, wearable devices and an electronic reader.

A “fixed electronic device” (FED) as used herein and throughout this disclosure, refers to a wireless and/r wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, a wearable device, and a multimedia player.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, and sensors.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, an online retailer, a utility, an own brand provider, a value added reseller (VAR), and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “manufacturer” or “original equipment manufacturer” (OEM) as used herein may refer to, but is not limited to, a first party provider of a product, a part for a product, a kit of parts for a product, a sub-assembly, or an assembly to an enterprise and/or individual and/or group of individuals and/or individuals for use directly by them and/or re-sale/distribution/retail etc. A manufacturer and/or OEM may provide physical product(s) and/or software product(s). Said software product(s) may be for permanent and/or temporary installation upon a device, system, and/or equipment comprising a microprocessor or may be provisioned to said device, system, and/or equipment comprising a microprocessor remotely via a network. This includes, but is not limited to, manufacturers of original products, sub-contract manufacturing for a manufacturer, and an after-sales product supplier. A manufacturer may not necessarily be the enterprise or company physically assembling and/or manufacturing the product, but rather the company or enterprise who have their name on the product for sale.

A “user” as used herein may refer to, but is not limited to, an individual or group of individuals about whom data including, but not limited to, personal data and biometric data may be, but not limited to, monitored, acquired, stored, transmitted, processed and analysed either locally or remotely to the user wherein by their engagement with a service provider, third party provider, enterprise, social network, social media, manufacture, OEM, etc. via a dashboard, web service, website, software plug-in, software application, graphical user interface acquires, for example, electronic content, a product, a service, and/or information. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by an ability to extract and process content presented and associate to defined actions etc.

A “consumer” as used herein may refer to, but is not limited to, a user and/or enterprise which is the intended final target acquirer/purchaser and/or consumer of a product and/or service. For example, a consumer may be the purchaser of a product directly from a retailer's physical store and/or online website.

A “shipper” or “national shipper” as used herein may refer to, but is not limited to, the provider of a service relating to the movement of a product or products from a first location to a second location within the same jurisdiction, e.g. a country, absent requirements for reporting activities relating to said movement when crossing boundaries within the jurisdiction. Such boundaries may include, but are not limited to, state, provincial, and municipal boundaries. Within certain specific instances, such as the European Community said boundaries may be national boundaries.

An “international shipper” as used herein may refer to, but is not limited to, the provider of a service relating to the movement of a product or products from a first location to a second location between jurisdictions wherein formalities relating to at least one regulatory authority, e.g. Customs, are required. As such an international shipper may ship, for example, from China to the United States, Canada to the United States, or the United States to Europe.

“Customs” as used herein may refer to, but is not limited to, an authority or agency in a country and/or jurisdiction responsible for collecting customs duties and for controlling the flow of goods, including animals, transports, personal effects, and hazardous items, into and out of that country and/or jurisdiction. For example, in the United States this may refer to the US Customs and Border Protection Agency, in Canada the Canada Border Services Agency, and in Europe the European Union Customs Union as enforced by each member state's organization(s) such as HM Revenue and Customs in United Kingdom, Swedish Customs in Sweden, and Federal Customs Service in Germany.

“User information” as used herein may refer to, but is not limited to, user behavior information, user profile information, and user credentials. It may also include a user's biometric information, an estimation of the user's biometric information, or a projection/prediction of a user's biometric information derived from current and/or historical biometric information. Such user information may be stored locally and/or remotely to the user.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Reference to a “Universal Product Code” (UPC) as used herein may refer to, but is not limited to, a barcode symbology (i.e., a specific type of barcode) that is widely used, for example in the United States, Canada, Europe and in other countries, for tracking trade items in stores. Formats may include, but not be limited to, UPC-A consisting of 12 numerical digits and EAN-13 (originally European Article Number) consisting of 13 numerical digits, which are uniquely assigned to each trade item. Such UPC/EAN barcodes are mainly used for scanning of trade items at the point of sale, per GS1 specifications (GS1 being a neutral, not-for-profit, international organization).

Reference to a “barcode” as used herein may refer to, but is not limited to, an optical machine-readable representation of data relating to an item to which it is attached and/or printed upon. A barcode may accordingly be scanned by a reader including, but not limited to, an optical barcode reader or wireless near-field communication, such as radio frequency identification (RFID) for example. A barcode employs a symbology mapping data to elements within the barcode as well as one or more other elements including, but not limited to, orientation markers, start-stop markers, quiet zones, and checksums. Such symbologies include, but are not limited to, linear symbologies, continuous symbologies, discrete symbologies, two-width symbologies, many-width symbologies, interleaved symbologies, matrix symbologies, and two-dimensional (2D) symbologies. Examples of linear and 2D or matrix symbologies may be found listed in Wikipedia, see http://en.wikipedia.org/wiki/Barcode#Symbologies, and therein the public domain references referred to. Some barcodes, e.g. QR codes, may further support multiple variants, comprising:
different models, e.g. QR code Model 1 and QR code Model 2;
different versions, e.g. QR code Version 1 at 21×21 and QR code Version 40 at 177×177; and
different error correction codes, e.g. L. M, Q. and H that support damage levels up to 7%, 15%, 25%, and 30%.

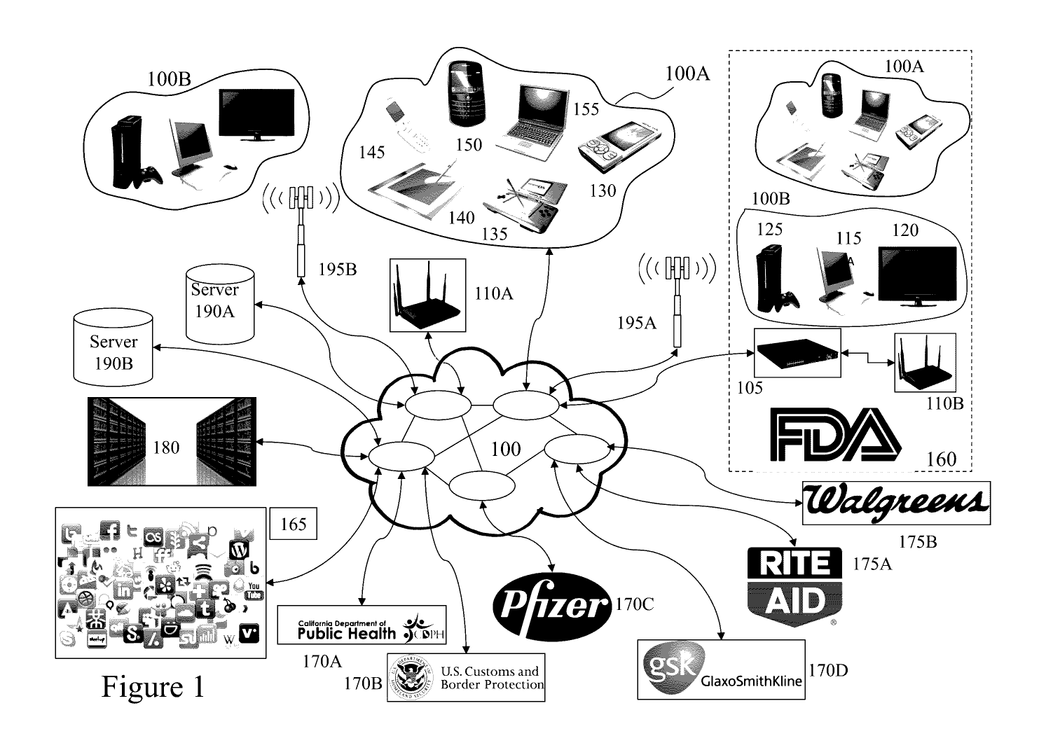

Referring to FIG. 1 there is depicted a network enviromnent 100 within which embodiments of the invention may be employed supporting Unique Label Systems, Applications, and/or Platform (ULSAPs) according to embodiments of the invention. Such ULSAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. US Food and Drug Administration™ (FDA), within which other first and second user groups 100A and 100B respectively are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 1109 are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first and second regulatory organizations 170A and 170B respectively, e.g. California Department of Public Health™ and US Customs and Border Protection™, first and second manufacturers 170C and 170D respectively, e.g. Pfizer™ and GlaxoSmithKline™, and first to second retailer entities 175A and 175B respectively, e.g. RiteAid™ and Walgreens™, as well as first and second servers 190A and 190B together with others, not shown for clarity. First and second servers 190A and 190B may host according to embodiments of the inventions multiple services associated with a provider of rating systems and rating applications/platforms (ULSAPs); a provider of a SOCNET or Social Media (SOME) exploiting ULSAP features; a provider of a SOCNET and/or SOME not exploiting ULSAP features; a provider of services to PEDS and/or FEDS; a provider of one or more aspects of wired and/or wireless communications; an Enterprise 160 exploiting ULSAP features; license databases; content databases; image databases; content libraries; customer databases; websites; and software applications for download to or access by FEDs and/or PEDs exploiting and/or hosting ULSAP features. First and second primary content servers 190A and 190B may also host for example other Internet services such as a search engine, financial services, third party applications and other Internet based services.

Accordingly, a user, for example a consumer or customer, may exploit a PED and/or FED within an Enterprise 160, for example, and access one of the first or second primary content servers 190A and 190B respectively to perform an operation such as accessing/downloading an application which provides ULSAP features according to embodiments of the invention; execute an application already installed providing ULSAP features; execute a web based application providing ULSAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

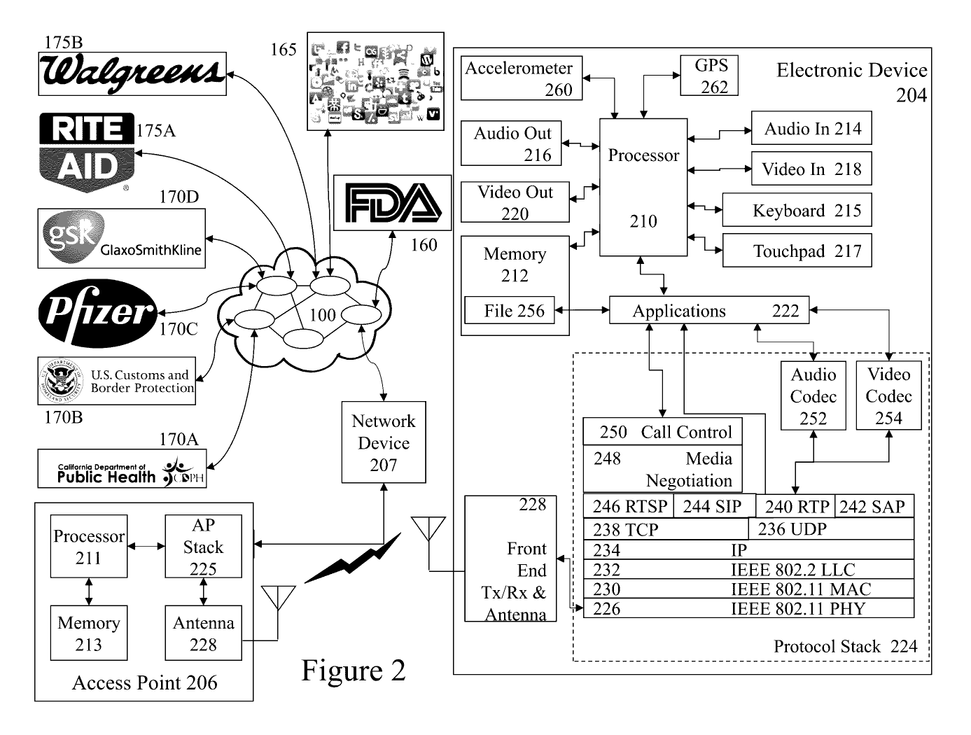

Now referring to FIG. 2 there is depicted an electronic device 204 and network access point 207 supporting ULSAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein SOCNETS 165, first and second regulatory organizations 170A and 170B respectively, e.g. California Department of Public Health” and US Customs and Border Protection™, first and second manufacturers 170C and 170D respectively, e.g. Pfizer™ and GlaxoSmithKline™, and first to second retailer entities 175A and 1.75B respectively, e.g. RiteAid™ and Walgreens™, and Enterprise 160, US Food and Drug Agency” (FDA).

The electronic device 204 includes one or more processors 210 and a memory 212 coupled to processor(s) 210. AP 206 also includes one or more processors 211 and a memory 213 coupled to processor(s) 210. Anon-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be apart of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232, Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of A.P 206. Typically, applications 222 may activate any of the SAP, SIP, RTSP, media negotiation and call control modules for that purpose. Typically, information may propagate from the SAP. SIP, RTSP, media negotiation and call control modules to PHY module 226 through TCP module 238. IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session. Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, 1TU-R 5.138, ITU-R 5.150, ITU-R 5.280, IMT-1000, DSL, Dial-Up, DOCSIS, Ethernet, G.hn, ISDN, MoCA, PON, and Power line communication (PLC).

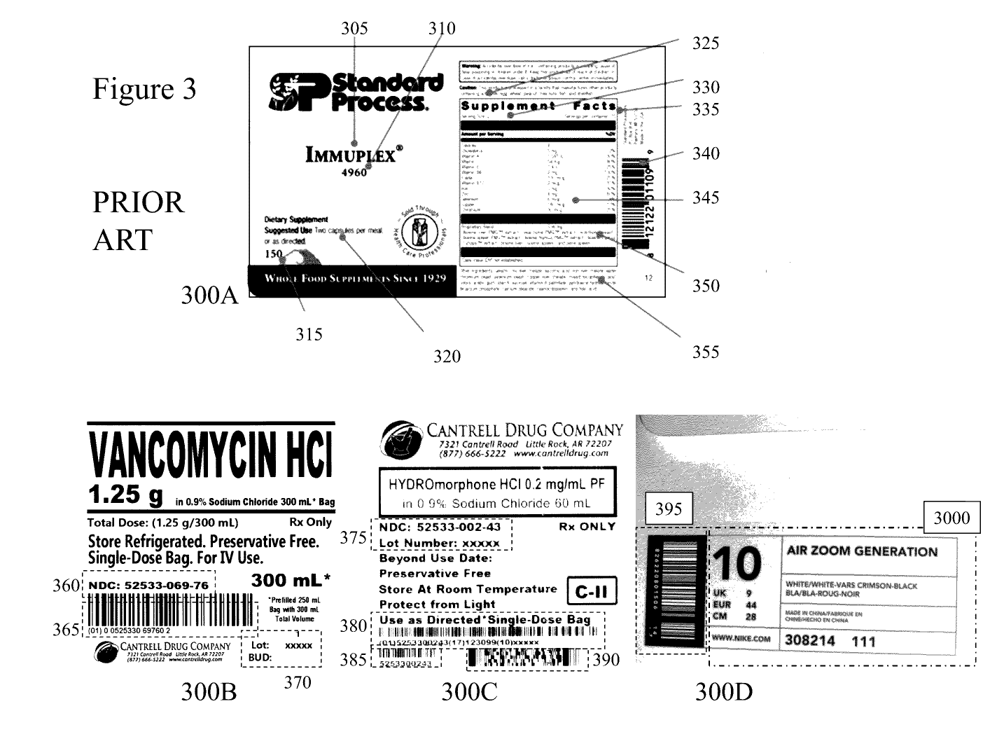

Referring to FIG. 3 there are depicted examples of prior art product labelling comprising first to fourth package labels 300A to 300D respectively. As depicted first package label 300A relates to exterior physical packaging for “Immuplex” as marketed by Standard Process. The physical packaging contains the following information for the consumer or user:
First text 305 providing the product name, e.g. “Immuplex”;
Second text 310 providing the product number as associated by the manufacturer, e.g. 4960;
Third text 315 providing an indication quantity of the item within the package, in this instance 150;
Fourth text 320 providing user suggested use information, e.g. 2 per meal as “Immuplex” is a dietary supplement;
Fifth text 325 provides warning and caution statements, which may for example be established by the manufacturer or a regulatory authority, e.g. FDA;
Sixth text 330 provides serving size information for association with ninth text 345, e.g. 2 capsules;
Seventh text 335 provides data such as servings per container or similar use related data, e.g. 75 servings;
Eighth text 340 provides Universal Product Code (UPC) in numeric and barcode formats;
Ninth text 345 provides nutrient claims for the product;
Tenth text 350 outlining proprietary components of the product; and
Eleventh text 355 outlining non-proprietary components of the product.

Referring to second to fourth package labels 300B and 300D, which relate to vancomycin hcl (vancomycin hydrochloride—an antibiotic); HYDROmorphone Hcl (hydromorphone hydrochloride—an opiate receptor blocker); and Air Zoom Generation shoes respectively. With these there are similarly depicted
First field 360, providing a national drug code (NDC) and depicted as “52533-069-76”;
First barcode 365, encoding the NDC with the code “(01) 0 052533 069760 2”;
Second field 370, providing a lot identity (ID) and depicted as “XXXX”;
Third field 375, providing an NDC code (52533-002-43) and lot ID “xxxxx”;
Second bar code 380, encoding the NDC code together with additional information “(17)123099(10)” and lot ID “xxxxx”;
Third bar code 390, in PDF417 format; and
Fourth bar code 395, providing a UPC code, e.g. “826220801506” with checksum “14.”

Accordingly, it would be evident that first and fourth package labels 300A and 300D respectively provide general information and UPC codes for the retailer's point-of-sale (PoS)/inventory systems. Nothing within either of first and fourth package labels 300A and 300D respectively, is unique. Accordingly, the purchaser of the products associated with these package labels has nothing that allows them to validate that the item(s) are indeed legitimate and original. For example, in the instance of first package label 300A replication of this label with package contents comprising 150 capsules filled with water would provide the user with no information that they were purchasing a fake product. Similarly, 150 yeast tablets, 150 chalk tablets, etc. would appear OK to most users unless the user looks online and there is a clear mismatch between what is in the box and what is listed online. In this instance “Immuplex” is available online from a range of online retailers including Amazon™. Further, wider options are provided to a counterfeiter where the product is available in multiple formats.

With fourth package label 300D as this is a UPC code for use by the retailer at their PoS then the user would have no knowledge of whether the UPC was correct or incorrect if the retailer's PoS accepts the code and provides the user with a receipt stating “Nike Air Zoom Generation.” As the retailer will program their PoS to associate a UPC with pricing information and/or information to be printed upon the purchaser's receipt then the user has no knowledge of whether the UPC is correct and the vast majority of users would not even think of looking up the UPC. In this instance the UPC “826220801506” in fourth bar code 395 is actually an invalid UPC code not associated with any product. Further, the user may not be aware of what a pair of “Nike Air Zoom Generation” trainers should look like and hence accepts the product on the shelf as genuine. In other instances, the user would know what the item is supposed to look like but might not be able to tell the difference between a pair of “Nike Air Zoom Generation” trainers made legitimately by Nike™ versus another pair made by the same or another manufacturer and reaching the consumer via either a different supply chain to that of the legitimate Nike™ or being merged with the legitimate Nike™ supply chain.

Similar situations arise with second and third labels 300B and 300C relating to vancomycin hydrochloride and hydromorphone hydrochloride. Whilst each includes identification of the drug in association with its NDC, a lot number, and a Beyond Use Date (BUD) there is nothing to indicate that the product to which the label is attached is actually manufactured by Cantrell Drug Company (Cantrell). As such there is nothing to identify the batch quantity so that if the physician's office, pharmacy, hospital has a quantity of 100 or 1,000 does this match or fit within the lot (batch) size of Cantrell. Equally, nothing defines that the lot (batch) number is actually a valid batch number and that the BUD/lot number are associated correctly. In most instances, medical personnel would be focussed to BUD and issues such as lot number tend to only arise in product recalls or in the event of an issue. However, if the manufacturer recalls a lot number not matching inventory then the “fake” inventory is maintained. Establishing such information can be difficult even within well-organized medical facilities in North America and Europe, yet alone in the field in remote/impoverished areas or in response to emergencies.

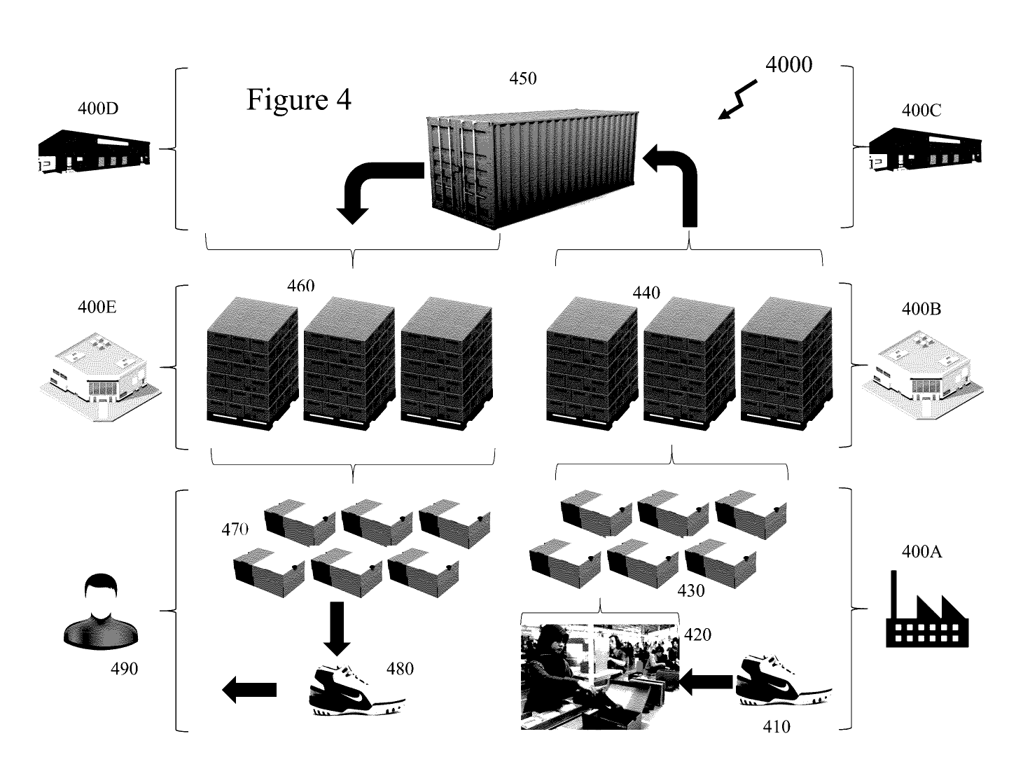

Accordingly, it would be beneficial to establish product labelling that allows such issues relating to the verification of a product as being valid to be addressed. Referring to FIG. 4 there is depicted a simplified exemplary flow 4000 for a product from a manufacturer 400A to a consumer 490. In flow 4000 a manufacturer 400A establishes a product 410, in this instance a pair of Nike™ athletic trainers, which are then packaged in step 420 into a product package 430, e.g. a box in this instance comprising standard printed elements such as product name, brand, size, etc. as indicated by printed region 3000 in respect of fourth package label 3000D in FIG. 3 where the UPC codes has been added later through the addition of a self-adhesive label. These packaged products 430 are then palletized by a first shipper 400B onto pallets 440 and delivered to first international shipper 400C for international shipping. Alternatively, the first shipper 400B may deliver to the first shipper 400C for national shipping by rail freight or road freight over larger distances, e.g. coast to coast across continental United States, across continental Europe etc. Optionally, first shipper 400B may support deliveries to local retailers and/or other shippers, such as second shipper 400E. However, within the descriptions of embodiments of the invention the longest supply chain is described and addressed although it would be evident to one of skill in the art that the embodiments of the invention may be equally applied to shorter supply chains as well as supply chains with different logistical steps than those described in respect of FIGS. 4 to 14.

First international shipper 400C then containerizes the palletized products within a container 450 which may be one of a range of predetermined sizes such as, for example, 20 feet containers, 40 feet containers, 40 feet high-cube containers, and those complying with ISO 6346, ISO 668, ISO 1161, and ISO 1496. The container 450 may be an intermodal container. The pallets 440 may be the sole cargo within the container 450 or other products and/or items may also be co-containerized with them. Considering international shipping such as China to United States (US), Philippines-Europe, etc. then the container 450 is loaded onto a freighter, not shown for clarity, for ocean shipment to a receiving port and dock wherein it is unloaded and transferred to second international shipper 400D who liaises with the appropriate customs agent(s) to bring the products into the country. The container is unloaded by second international shipper 400D allowing the palletized product to be transferred to second shipper 400E wherein they are then transferred to the retailer(s) distribution depot(s), not shown for clarity, via the pallet(s) 460. From the retailer's distribution depot, the product is then distributed to the customer 490 via online and/or physical means as known in the prior art. When the customer 490 purchases their retail product 480 then in many instances its product packaging 470 and labelling associated with it are discarded at the retailer or shortly thereafter.

Accordingly, it would be evident that, even for an enterprise having their own manufacturing and retail operations that for significant portions of their overall logistical supply chain their product(s) are out of their control and accordingly that the replacement/substitution of the product(s) with counterfeit product(s) can occur throughout the remainder of the supply chain. In other instances, the counterfeit product may be introduced directly at the manufacturing operations where these are sub-contracted and/or at the retailer.

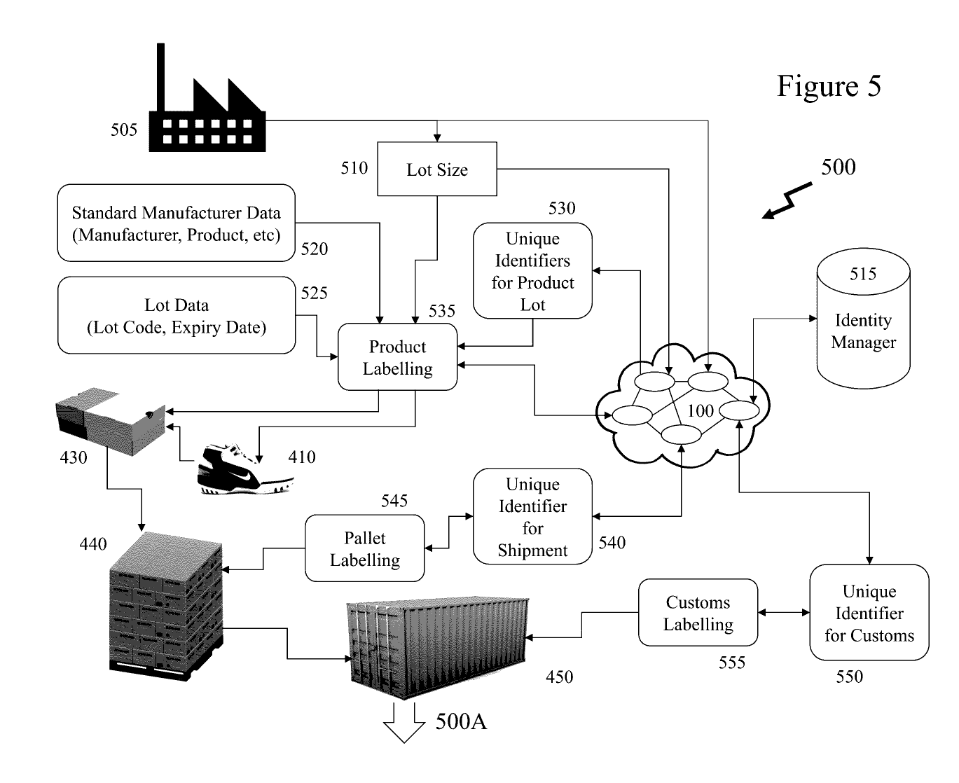

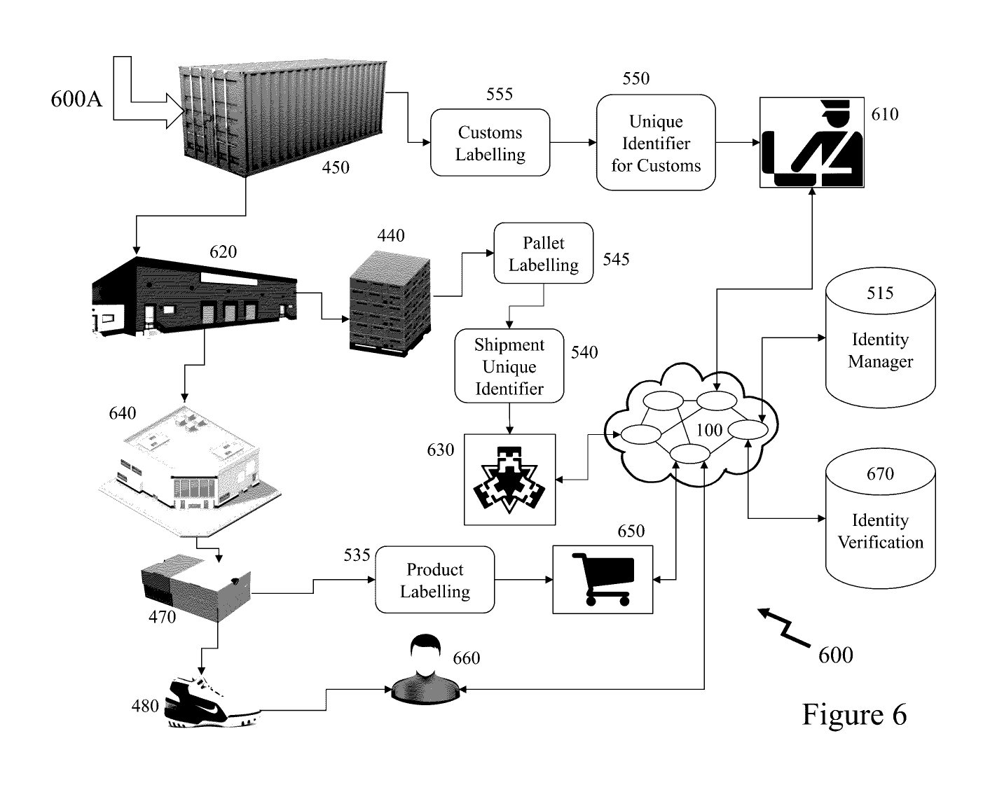

Now referring to FIG. 5 there is depicted an exemplary process flow 500 for a product from manufacturer 505 to shipping in a container 450 according to an embodiment of the invention. As depicted, a manufacturer, i.e. OEM 505, is interconnected via a network 100 to an Identity Generator (IDGen) 515. At a point in their operations the OEM 505 determines to manufacture a batch of product 410 and determines a manufacturing lot size in step 510. This lot size data is communicated to the IDGen 515 which returns a set of unique identifiers in step 530 for the product lot identified by the OEM 505. Accordingly, in step 535 the individual products are labelled with a combination of data including, but not limited to, standard manufacturing data such as manufacturer's name, product name, etc.; lot data such as lot code, expiry date (if applicable), etc,; and a unique identifier from the set of unique identifiers provided by the IDGen 515. At step 535 this labelling is also associated with product packaging 430. Subsequently, a batch is to be prepared for shipment wherein the OEM 505 triggers the shipment process that results in IDGen 515 providing a unique identifier for shipment that is then merged with additional data such as manufacturer, location of origin, destination location, destination enterprise, etc. This information is then applied to the associated documentation and/or packaged products, e.g. pallet 440 after palletization.

Where the OEM 505 has triggered a shipment that requires containerization and other steps such as international freight, customs clearance, etc. then the OEM 505 communicates such a step to the IDGen 515 which then generates data relating to those steps including, for example, a unique identifier for the shipment with customs and labelling information for the customs process. These are then applied to the documentation and/or shipment container 450. At this point the process proceeds via a shipment process that initiates with step 500A and ends with step 600A in FIG. 6 which depicts an exemplary process flow 600 for a product from shipper to consumer according to an embodiment of the invention. Upon receipt of the shipment container 450 at customs 610 the customs labelling 555 and unique identifier information 550 is retrieved and communicated by customs 610 via network 100 to Identity Verification (IDVer) 670 which communicates with one or more databases including, but not limited to, IDGen 515.

Once the container 450 has cleared the customs process then it proceeds to receiving shipper location 620 wherein it is broken down to the pallets 440 and the associated pallet labelling 545 and unique shipment identifier 540 are communicated to the receiving shipper 630 wherein the receiving shipper 630 can similarly verify the data by communicating to the IDVer 670. Subsequently, the product(s) are transferred to retailer depot(s) 640 and thereafter retailer locations or directly to the retailer location(s) 650. Within the retail location 650 the retailer's staff and/or the customer 660 may verify data relating to the retail product 480 through labelling 535 applied to the product packaging 470 or to the product itself 480. Accordingly, through the retail location 535 PEDs and/or FEDs or the user 660 verification data relating to the product that the user 660 is about to purchase and/or has purchased can be verified through IDVer 670.

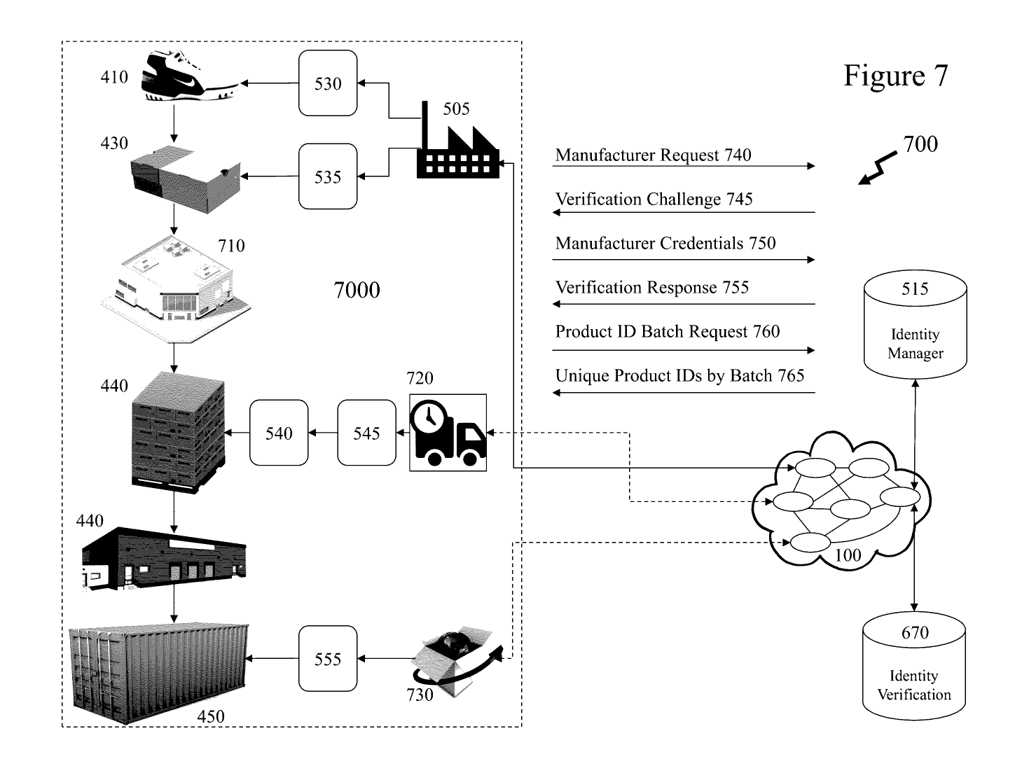

Within FIGS. 7 to 13 exemplary messaging flows relating to the different stages of identity generation and/or identity verification are presented. Considering initial FIGS. 7 to 9 these refer to first to third message flows 700 to 900 respectively. Each of these messages relates to a step in a manufacturing—shipping flow 7000. Within manufacturing—shipping flow 7000 an OEM 505 manufactures a product 410 which is then packaged as packaged product 430 from product 410 via packaged product 430 with unique identifiers 530 and product labelling 535 applied to these. These are routed via shipping location 710 and palletized as pallets 440 wherein the shipper 720 employs pallet labelling 545 and shipment unique identifier 540. After palletization the pallet 440 is containerized by international shipper 730 at a shipping location 40 via container 450 employing customs labelling 555.

As depicted in FIG. 7 the message flow 700 relates to the OEM 505 at the product manufacturing 410 and product packaging 430 steps engaging a ULSAP which comprises, as depicted, a first remote server providing identity management functions, Identity Manager 515, and a second remote server providing identity verification functions, Identity Verification 670. Their engagement establishing unique identifiers 530 and product labelling 535 which are applied during these product manufacturing 410 and product packaging 430 steps.

As depicted message flow 700 comprises:
Manufacturer Request 740, wherein the OEM 505 accesses the ULSAP providing, for example their identity and a unique credential such as known within the prior art;
Verification Challenge 745, wherein the ULSAP sends a challenge to the OEM 505 requesting verification of their identity;
Manufacturer Credentials 750, wherein the OEM 505 provides additional certificates, credentials, security keys, etc. as required in order for the OEM 505 to register upon the ULSAP as a verified authenticated manufacturer and hence legitimately entitled to be issued with a set of unique product identities. Such credential exchange and verification process in response to the verification challenge may be performed according to one or more methodologies as known within the art;
Verification Response 755, wherein the ULSAP provides a response to the OEM 505 indicating whether the credentials provided have been accepted;
Product ID Batch Request 760, wherein the OEM 505 sends a request for unique product identities (IDs) to the ULSAP wherein the request, for example, standard manufacturing data from the OEM 505 such as the identity of the product, the quantity of products within the lot/batch for which identities are required, manufacturing location, manufacturer identifiers, etc. Optionally, the OEM 505 may provide additional data including, but not limited, to expiry date (Best Use Date), product colour if batch/lot specific, product size, and manufacturing date; and
Unique Products IDs by Batch 765, wherein the ULSAP returns to OEM 505 a series of unique IDs generated by the Identity Manager 515 which the OEM 505 then includes within the labelling processes of the product and/or product packaging such as depicted and described in respect of FIG. 4.

Accordingly, activities in steps 740 to 755 may be handled by the Verification Manager 670 whilst steps 760 and 765 may be handled by the Identity Verification 670. Within embodiments of the invention the unique identifiers may be transmitted in encrypted form from the Identity Manager 515 to the OEM 505, may be transmitted as simple alphanumeric IDs, may be transmitted as encoded machine readable IDs according to a predetermined standard by the ULSAP, or may be transmitted as encoded machine readable IDs according to a predetermined standard established by the OEM 505 within Product ID Batch Request 760. Accordingly, the OEM 505 as depicted in FIG. 4 adds the unique product ID to its product and/or product packaging either through a direct marking/printing process or through an alternate process as known within the art such as through adhesive labels etc. Any appropriate methodology of marking the product and/or product package may be applied according to embodiments of the invention.

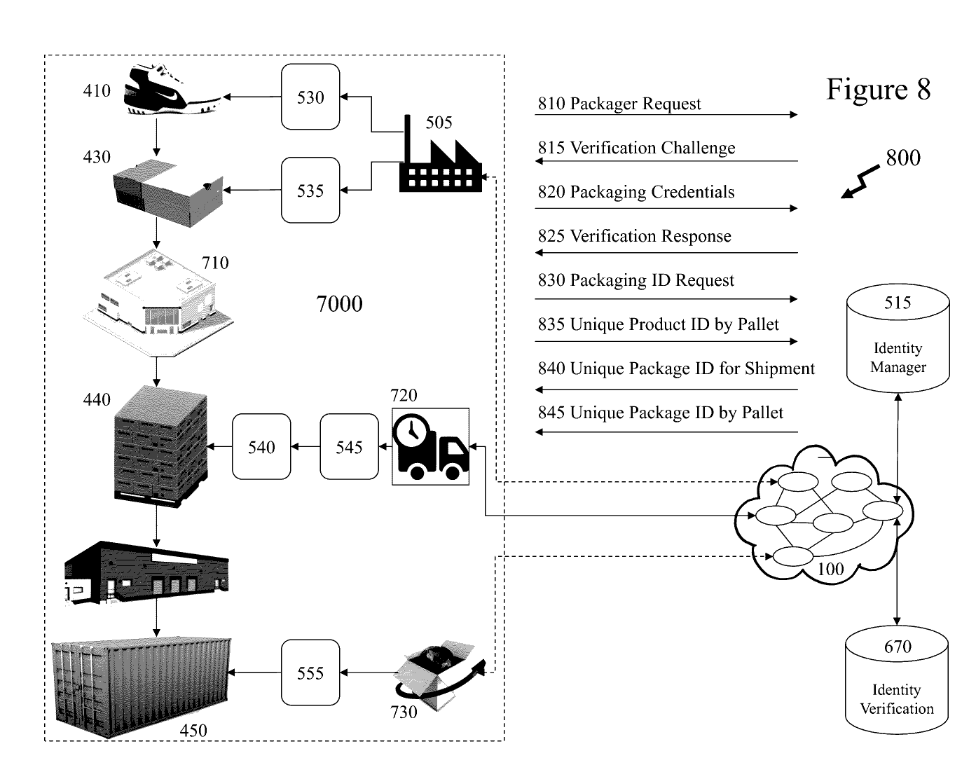

As depicted in FIG. 8 the message flow 800 relates to the shipper 720 at the product shipping stage with palletization into pallets 440 engaging a ULSAP which comprises, as depicted, a first remote server providing identity management functions, Identity Manager 515, and a second remote server providing identity verification functions, Identity Verification 670. As depicted message flow 800 comprises:
Packager Request 810, wherein the shipper 720 accesses the ULSAP providing, for example their identity and a unique credential such as known within the prior art;
Verification Challenge 815, wherein the ULSAP sends a challenge to the shipper 720 requesting verification of their identity;
Packager Credentials 820, wherein the shipper 720 provides additional certificates, credentials, security keys, etc. as required in order for the shipper 720 to register upon the ULSAP as a verified authenticated shipper and hence legitimately entitled to be issued with a set of unique packaging identities;
Verification Response 825, wherein the ULSAP provides a response to the shipper 720 indicating whether the credentials provided have been accepted;
Packaging ID Request 830, wherein the shipper 720 sends a request for unique packaging identities (IDs) to the ULSAP wherein the request, for example, standard packaging data from the shipper 720 such as the identity of the shipper, the quantity of products being packaged, the packaging location, product identity, product manufacturer etc.;
Unique Product IDs by Pallet 835, wherein the shipper 720 provides the unique product identities of the products as grouped according to the pallet (or other package grouping employed);
Unique Packager ID for Shipment 840, wherein the ULSAP returns to shipper 720 a unique ID generated by the Identity Manager 515 which the shipper 720 then includes within the labelling processes of all pallets etc. for the shipment; and Unique Package ID for Shipment 845, wherein the ULSAP returns to shipper 720 a set of unique IDs generated by the Identity Manager 515 which the shipper 720 then includes within the labelling processes of the pallets etc. for the shipment such that each pallet has a unique Package ID in combination with a unique Packager ID allowing the pallets to the uniquely identified as well as the overall shipment.

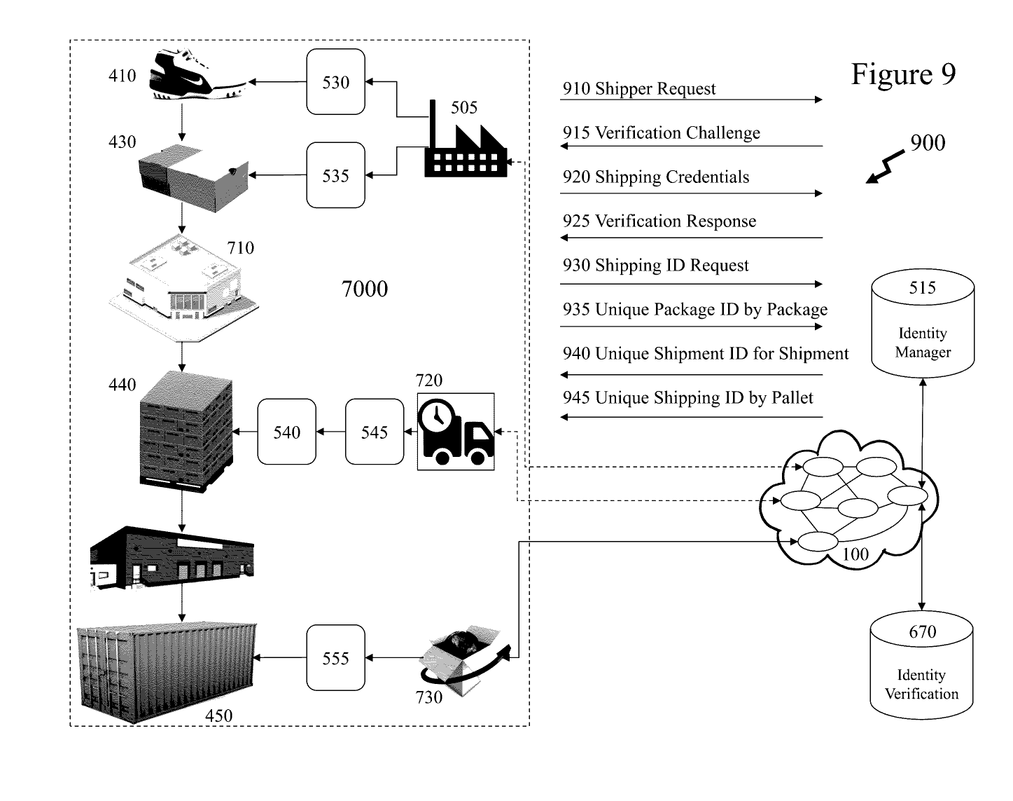

As depicted in FIG. 9 the message flow 900 relates to the international shipper 730 at the product shipping stage with containerization of the pallets 440 into container 450. As such the international shipper 730 engages a ULSAP which comprises, as depicted, a first remote server providing identity management functions, Identity Manager 515, and a second remote server providing identity verification functions, Identity Verification 670. As depicted message flow 900 comprises:
Packager Request 910, wherein the international shipper 730 accesses the ULSAP providing, for example their identity and a unique credential such as known within the prior art;
Verification Challenge 915, wherein the ULSAP sends a challenge to the international shipper 730 requesting verification of their identity;
Packager Credentials 920, wherein the international shipper 730 provides additional credentials to verify themselves as legitimately entitled to be issued with a set of unique shipping identities;
Verification Response 925, wherein the ULSAP provides a response to the international shipper 730 indicating whether the credentials provided have been accepted;
Shipping ID Request 930, wherein the international shipper 730 sends a request for unique shipping identities (IDs) to the ULSAP wherein the request, for example, standard shipping data from the international shipper 730 such as the identity of the shipper, the quantity of packages being shipped, the shipping point of origin, pallet identities, etc.;
Unique Package IDs by Pallet 935, wherein the international shipper 730 provides the unique identities of the pallets as grouped according by container;
Unique Shipment ID for Shipment 940, wherein the ULSAP returns to international shipper 730 a unique ID generated by the Identity Manager 515 which the international shipper 730 then includes within the labelling processes of all containers etc. for the shipment; and
Unique Shipping ID by Pallet 945, wherein the ULSAP returns to international shipper 730 a set of unique IDs generated by the Identity Manager 515 which the international shipper 730 then includes within the labelling processes of the pallets etc. for the shipment such that each pallet has a unique Shipping ID in combination with a unique Shipment ID allowing the shipping container associated with the pallets to be uniquely identified as well as the overall shipment.

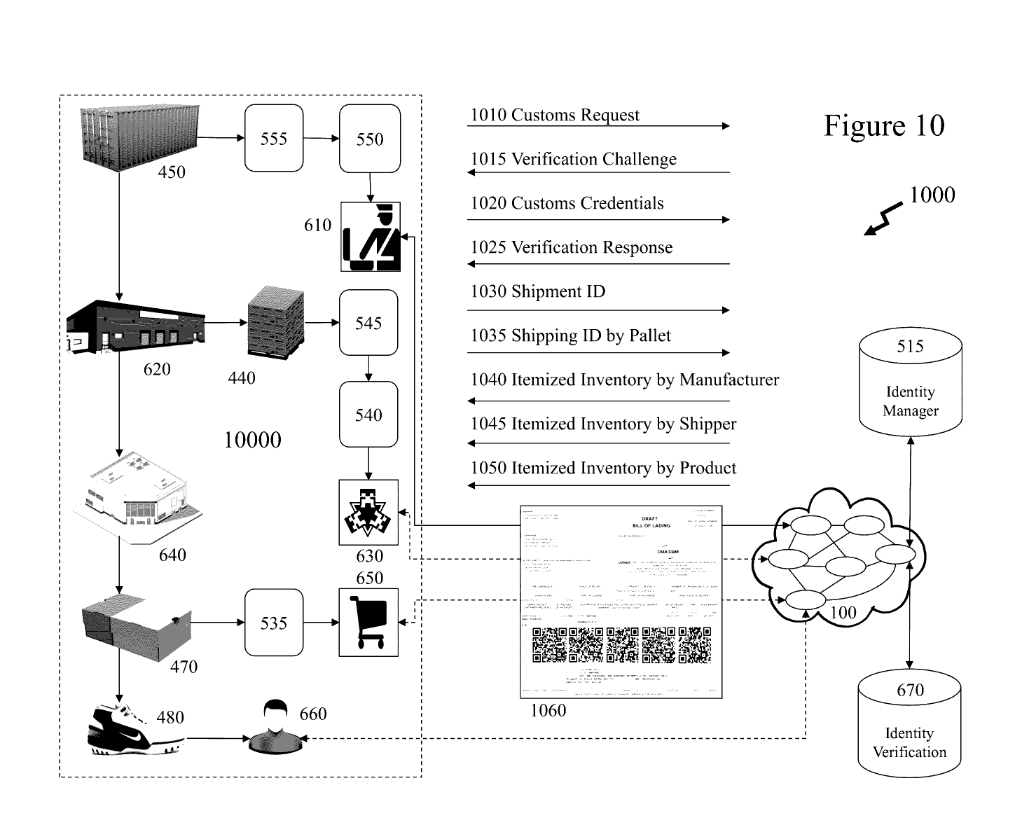

Within FIGS. 7 to 13 exemplary messaging flows relating to the different stages of identity generation and/or identity verification are presented. Considering FIGS. 10 to 13—these refer to fourth to seventh message flows 1000 to 1300 respectively. Each of these messages relates to a step in a shipping—retail flow 10000. Within shipping—retail flow 10000 then the steps from receipt of a container 450 to retail product 480 are presented wherein the container 450 is initially processed by customs 610 using customs labelling 555 and unique identifier information 550. Subsequently, cleared shipments progress via receiving shipper location 620 wherein it is broken down to the pallets 440 and the associated pallet labelling 545 and unique shipment identifier 540 are communicated by the receiving shipper 630 to the ULSAP. Subsequently, the product(s) are transferred to retailer depot(s) 640 and thereafter retailer locations or directly to the retailer location(s) 650. Within the retail location 650 the retailer's staff and/or the customer 660 may verify data relating to the retail product 480 through labelling 535 applied to the product packaging 470 or to the product itself 480.

As depicted in FIG. 10 the message flow 1000 relates to clearance of the container 450 by customs 610. As depicted the customs 610 engages a ULSAP which comprises, as depicted, a first remote server providing identity management functions, Identity Manager 515, and a second remote server providing identity verification functions, Identity Verification 670. As depicted message flow 1000 includes information encoded onto a manifest 1060 although it would be evident that the information may be transmitted and/or acquired by the ULSAP and/or customs 610 through other communications channels and/or means. Message flow 1100 as depicted comprises:
Customs Request 1010, wherein the international shipper 730 accesses the ULSAP providing, for example their identity and a unique credential such as known within the prior art;
Verification Challenge 1015, wherein the ULSAP sends a challenge to customs 610 requesting verification of their identity;
Customs Credentials 1020, wherein customs 610 provides additional credentials to verify themselves as legitimately entitled to be issued with data relating to the container;
Verification Response 1025, wherein the ULSAP provides a response to customs 610 indicating whether the credentials provided have been accepted;
Shipment ID 1030, wherein customs 610 sends the ULSAP the shipment identifier information associated with the container, namely unique identifier for shipment 550. This information provided originally (if legitimate) by the ULSAP to the international shipper 720 in response to their request which was provided in step 940 Unique Shipment ID for Shipment in FIG. 9;
Shipping ID by Pallet 1035, wherein customs 610 sends the ULSAP the shipment identifier information associated with the container, namely customs labelling 555. This information provided originally (if legitimate) by the ULSAP to the international shipper 720 in response to their request which was provided in step 945 Unique Shipping ID by Pallet in FIG. 9. This information being part of the declarations submitted with the container 450 to customs 610 by the international shipper at the destination port for clearance;
Itemized Inventory by Manufacturer 1040, wherein the ULSAP in response to valid container and pallet shipping IDs provides to customs an itemized inventory of the contents of container 450 by their originating manufacturer;
Itemized Inventory by Shipper 1045, wherein the ULSAP in response to valid container and pallet shipping IDs provides to customs an itemized inventory of the contents of container 450 by their originating shipper as materials from multiple shippers 720 may in some instances be consolidated to a single container 450;
Itemized Inventory by Product 1050, wherein the ULSAP in response to valid container and pallet shipping IDs provides to customs an itemized inventory of the contents of container 450 by their product type.

It would be evident to one of skill in the art that in principle, a single container ID scanned and acquired by customs 610 may yield through accessing a ULSAP according to embodiments of the invention a complete itemized inventory by product, manufacturer, and originating shipper. Further, within an ancillary process flow associated with customs 610, not depicted for clarity, the access to ULSAP may provide customs 610 with additional information as part of process flow 1000 or as part of an ancillary process flow such as originating manufacturing location, manufacturing dates, etc. Accordingly, customs 610 may rapidly process a container 450 for allowance into the jurisdiction to which customs 610 are associated as well as allowing the automated calculation y tariffs etc. due arising from the product, quantity, manufacturing origin etc.

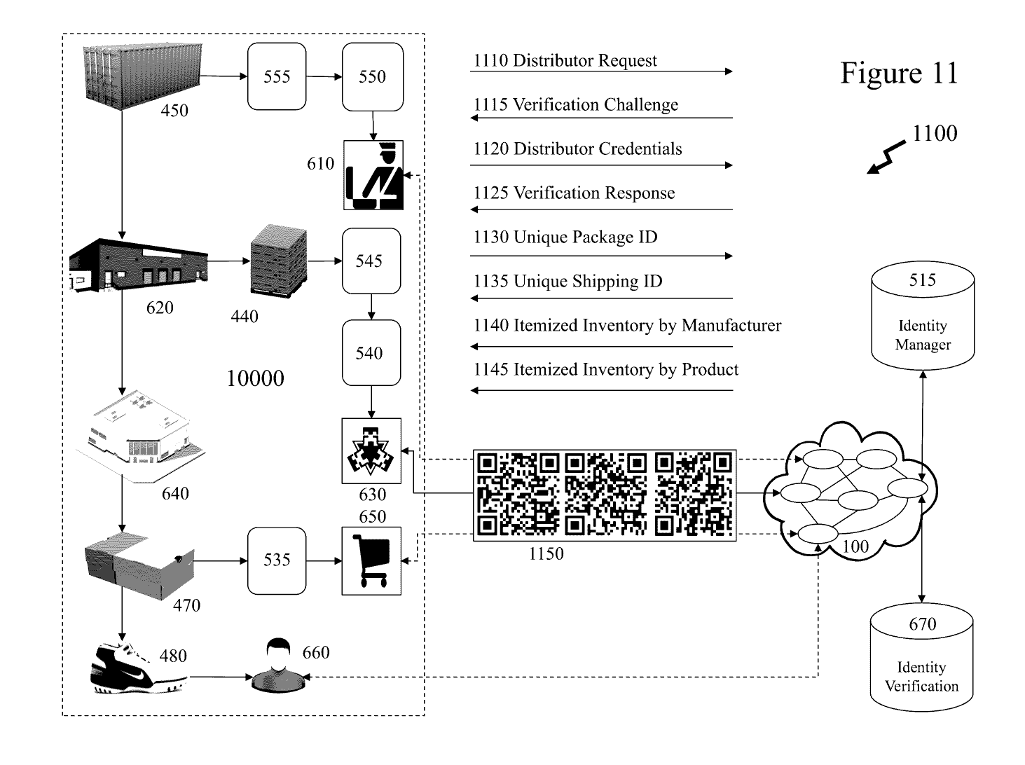

As depicted in FIG. 11 the message flow 1100 relates to validation of a pallet 440 by a receiving shipper 630 once it has cleared customs 610 before distributing the product to the retail location(s) 640. As depicted the receiving shipper 630 engages a ULSAP which comprises, as depicted, a first remote server providing identity management functions, Identity Manager 515, and a second remote server providing identity verification functions, Identity Verification 670. As depicted message flow 1100 comprises:
Distributor Request 1110, wherein the receiving shipper 630 accesses the ULSAP providing, for example their identity and a unique credential such as known within the prior art;
Verification Challenge 1115, wherein the ULSAP sends a challenge to receiving shipper 630 requesting verification of their identity;
Customs Credentials 1120, wherein receiving shipper 630 provides additional credentials to verify themselves as legitimately entitled to be issued with data relating to the container;
Verification Response 1125, wherein the ULSAP provides a response to the receiving shipper 630 indicating whether the credentials provided have been accepted;
Unique Package ID 1130, wherein receiving shipper 630 sends the ULSAP the shipment identifier information associated with the pallet, this being the information provided originally (if legitimate) by the ULSAP to the shipper 720 in response to their request which was provided in step 840 Unique Packager ID for Shipment in FIG. 8;
Unique Shipping ID 1135, wherein shipper 630 sends the ULSAP the shipment identifier information associated with the container, this being the information provided originally (if legitimate) by the ULSAP to the shipper 630 in response to their request which was provided in step 845 Unique Package ID by Pallet in FIG. 8;
Itemized Inventory by Manufacturer 1140, wherein the ULSAP in response to valid packager and package IDs provides to receiving shipper 630 an itemized inventory of the contents of container 450 by their originating manufacturer; and
Itemized Inventory by Product 1145, wherein the ULSAP in response to valid container and pallet shipping IDs provides to receiving shipper 630 an itemized inventory of the contents of container 450 by their product type.

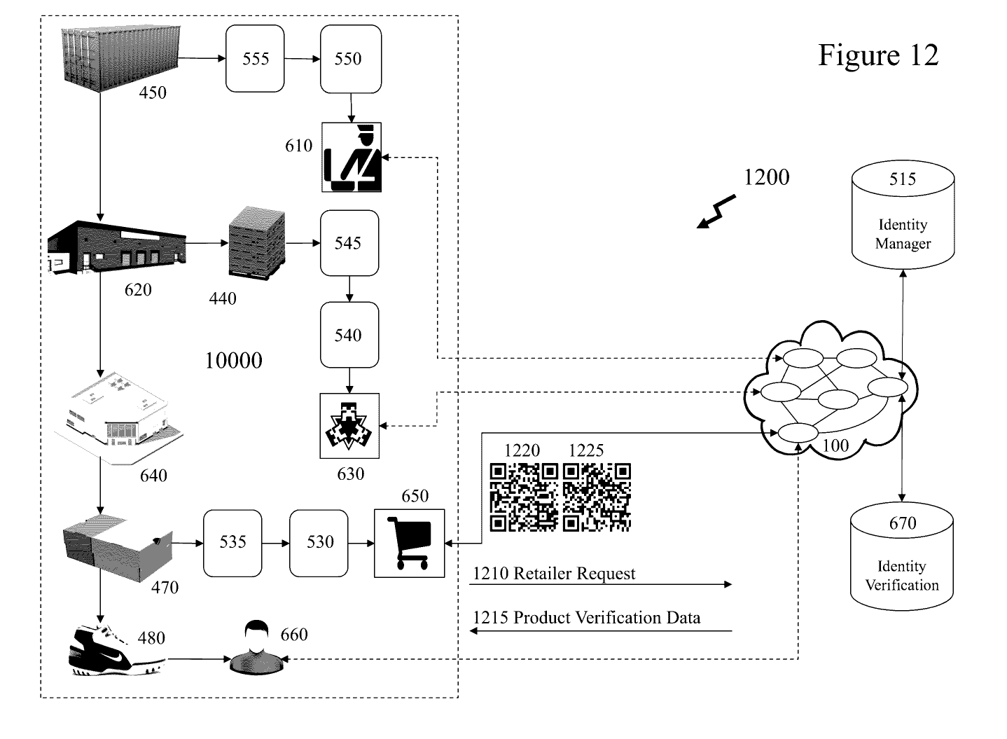

The information in steps 1130 and 1135 may be send as multiple messages or a single message 1150. The message(s) may be unencoded, encoded, encrypted, etc. Now referring to FIG. 12 there is depicted a message flow 1200 relates to validation of a product 470 by a retailer location 650 either as part of their routine operations or at the request of a customer. As depicted the receiving shipper 630 engages a ULSAP which comprises, as depicted, a first remote server providing identity management functions, Identity Manager 515, and a second remote server providing identity verification functions, Identity Verification 670. As depicted message flow 1200 comprises:
Retailer Request 1210, wherein the retailer from retailer location 630 transmits product labelling 535 and unique product ID 530 information, depicted as first and second Quick Response QR) codes 1220 and 1225, to the ULSAP; and
Product Verification Data 1220 which returns a response in respect of the retailer request 1210 as to whether the first and second QR codes 1220 and 1225 provided identifying the product labelling 535 and unique product ID 530 are valid.

As will become evident in descriptions with respect to embodiments of the invention below such requests may be limited with respect to repeated attempts such that, for example, a unique identifier code associated with a product at manufacturing and subsequently employed is valid for a single verification after which it automatically fails verification. In this manner a unique product ID cannot be employed on multiple counterfeit products where the customer/retailer/user can access the ULSAP and determine that in fact the unique product ID is no longer valid or was never valid and therefore that they are being presented with counterfeit or non-legitimate product. For example, retailer request 1210 may be performed at a point-of-sale (PoS) when a customer purchases a product allowing the customer to verify that they are purchasing an authentic product at the PoS such that counterfeit product cannot be inserted into the retail chain by, for example, sales staff or retail management to generate revenue that is not pocketed as to the manufacturer of the legitimate product no product has been sold. As such a process flow such as depicted in FIG. 12 may be performed absent any account registration allowing open access.

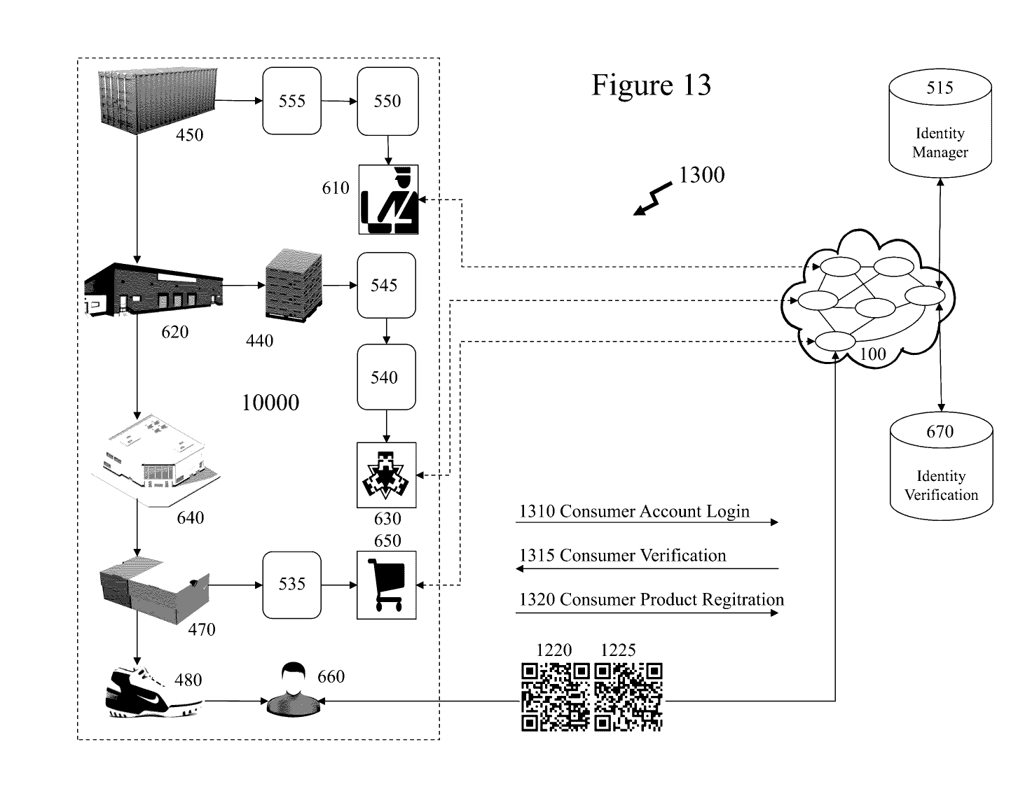

Now referring to FIG. 13 there is depicted an exemplary message flow 1300 between a consumer, user 660, and a ULSAP according to an embodiment of the invention. As depicted message flow 1300 comprises:
Consumer Account Login 1310 wherein a user 660 has established an account with an ULSAP according to an embodiment of the invention and provide standard login credentials as known in the prior art;
Consumer Verification 1315 wherein the ULSAP verifies the user through one or more approaches as known within the art including, for example, verifying a device identity of a PED and/or FED the user, verifying a biometric of the user, and requesting secondary credential/code submission; and
Consumer Product Registration 1320, wherein upon the user once they have been verified can register a product, such as through provisioning first and second QR codes 1220 and 1225 provided identifying the product labelling 535 and unique product ID 530.

In this manner a product once purchased can be registered to a user such that subsequently within embodiments of the invention the ownership of the product can be established and/or amended to reflect it being a gift, an asset sold, etc. such that subsequently the full chain of ownership can be maintained. This may, in some instances, only be offered as part of a subscription based account/service reflecting for example its application in respect of products that are of relatively high financial value, for example.

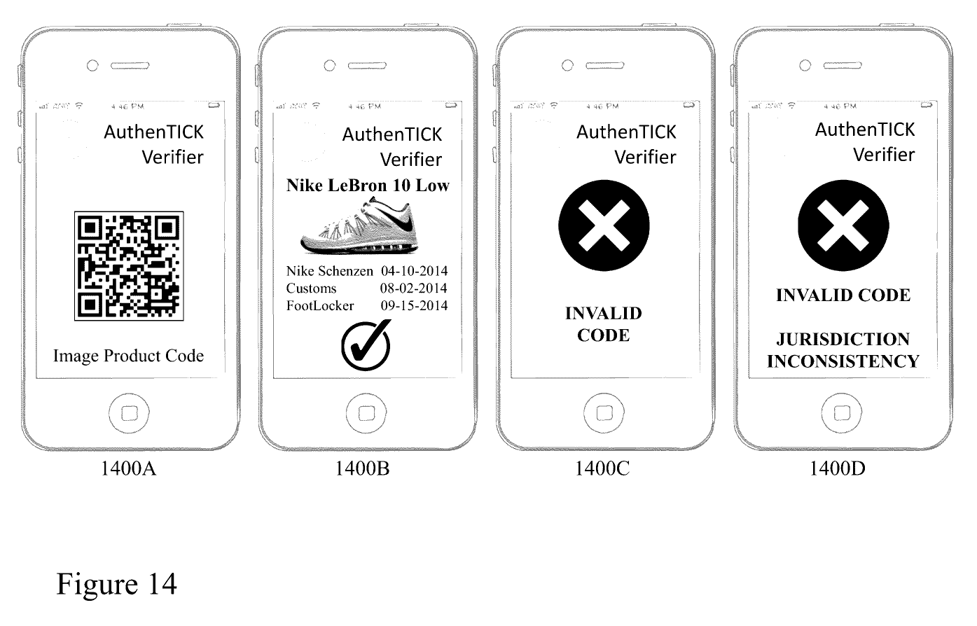

Now referring to FIG. 14 there are depicted exemplary screenshots of a ULSAP upon a user's PED during verification of a product within a retail environment. As depicted a user in first screenshot 1400A has acquired a product code image which is then communicated to a ULSAP such as described above in respect of FIG. 12 or 13. In second screenshot 1400B the ULSAP responds to the provided product code with a response indicating the following:
the code relates to a “Nike Lebron 10 Low” shoe;
an image of the product;
summary “history” of the product associated with the product code in terms of when manufactured, when cleared customs, and entered inventory at “Foot Locker”; and
visual indication that code is a valid code.

In contrast in third and fourth screenshots 1400C and 1400D the responses from the ULSAP are indicated to the user as being an invalid code. However, whilst third screenshot 1400C simply indicates an invalid code the fourth screenshot 1400D indicates that it is an invalid on the grounds that there is a jurisdiction inconsistency. For example, the product code is valid but the ULSAP product database associates the code with a product shipped to the United Kingdom whilst the request is coming from a California Internet Protocol (IP) address.

Accordingly, the process flows described and depicted in respect of FIGS. 4 to 13 according to embodiments of the invention relate to a method and system whereby The purpose of this document is to explain a system whereby a supply chain comprising end-user or customer/retail customer/retailer/shippers/authorities such as customs employ a series of unique IDs allowing different elements of the supply chain to verify that the product(s) they are inspecting/receiving/purchasing/selling/etc. are a genuine product of the manufacturer.

As outlined within the process flows described and depicted in respect of FIGS. 4 to 13 according to embodiments of the invention this is achieved through placing one or more unique identifiers (IDs) on each item to allow for the products authenticity to be verified. Each ID is uniquely generated, for example pseudorandomly generated, although it may be combined with other identity elements and/or identity attributes including, but not limited to “Manufacturer”, “Product”, “Date of Manufacture”, “Lot code”, and “Expiry Date”. The unique identity discretely or in combination with these other elements may be encoded within a machine readable code, such as a QR code, bar code, etc. or similar code that is attached or forms part of the item that may require validation. The integrity of systems embodying the invention is based upon the issuance of the unique referencable IDs only to an authorized manufacturer of the product, and as such, will require verification from the manufacturer that they are who they say they are. The manufacturer may also provide information for display to the end-user such as logos, and/or contact information for arty reason including non-genuine product concerns. Other elements of the supply chain apart from the manufacturer, such as domestic and/or international shippers may similarly be provided unique identities allowing, verification that a shipment received at another destination is what it purports to be especially where the shipment elements, e.g. container, pallet, etc. are packaged and/or sealed in a manner making inspection of the individual product(s) within the shipment difficult or impractical.

Accordingly, a unique ID may be generated and/or applied to each item that requires verification by another element within the supply chain. Accordingly, in the contexts described this includes, for example, the shipping container, the pallet, a retail product box, the retail item, or sub-components of the retail item. Within other embodiments of the invention the ID may also have reserved for it a fixed portion of an item or alternatively the ID may itself identify the type of package the ID is expected to be placed on based upon aspects of the ID such as size, dimensions, type of code, degree of encryption encoding employed. As noted supra in respect of FIGS. 4 through 13 every ID is unique so that even two identically manufactured products on the same manufacturing station machine are given different IDs even if due to common shipment and logistics other IDs associated with other stages of the supply chain are common and hence IDs relating to pallet, container etc. are common.

Each ID may include additional plain text alphanumeric content in addition to machine readable content. For example, each ID may be labelled for the type of end-user that is intended to verify the product supply chain at that point. For instance, there may be an ID labelled “For Customs Use” applied to the outside of the shipping container, e.g. painted or attached. Similarly, an ID may be labelled “For Customer Use” on the actual product.

As described supra in respect of the exemplary process flows described and depicted in respect of FIGS. 4 to 13 according to embodiments of the invention there are one or more servers allowing for the verification of parties within the supply chain, e.g. manufacturer, customs, etc. and the provisioning of information to verified authorised users in dependence upon the ID they provide. However, it is assumed in those exemplary process flows that the end-user/customer having access to the unique product ID may verify the ID without requiring logging into and/or being verified. The verification, for example, of a manufacturer can trigger the request for and the generation of a series of unique IDs for their manufactured products.

Accordingly, the remote verification server(s) would be able to “look-up” through one or more databases stored upon one or more remote identity servers whether an ID passed to it is one that was previously generated. The verification server may also store additional information about the ID including, but not limited to, shipping information, customs information, retail chain information, manufacturer recalls, stolen products, and IDs that have been registered by end users. Accordingly, a customer in verifying the legitimacy of a product, for example at a P0S terminal, may be informed that whilst the product is valid it has been recalled by the manufacturer or was part of a lot of products stolen. In some embodiments of the invention the remote verification may have additional security mechanisms such as limiting the maximum number of IDs that can be verified per day per user, or per network address, or other attribute. Other mechanisms may also be employed to prevent illegitimate users from hacking, or gaining information from the remote verification and/or identity servers.

For example, a consumer may pass an ID to a verification server to verify if the code is genuine. The consumer may, according to the type of code, manually enter the ID, or scan the ID by way of a QR-CODE or similar mechanism, as the ID is likely to long. The inventors refer to the action of passing an ID to the remote verification server as performing a scan. In some embodiments of the invention the system integrity also depends on the scans relating to IDs being performed by or in association with a known entity or equipment associated with a known entity.

Within other embodiments of the invention the unique ID associated with the product at its manufacture may be hidden by the manufacturer such that it cannot be accessed quickly and/or easily. For example, where the product has an opening/chamber/compartment for the insertion of a battery (batteries) or other element of the product then the unique ID code of the product may be attached within this opening/chamber/compartment or a cover/panel etc. associated with the opening/chamber/compartment. Alternatively, the ID in its encoded format may be hidden through other mechanisms such as for example via provisioning of a tamper evident element in association with the unique encoded ID attached to the product and/or etched/stamped/cut into the product. For example, the unique encoded ID may be covered by a flap/removable tape such that the user can see whether the ID has been previously accessed and/or scanned.

Within embodiments of the invention the unique ID code of the product may he implemented within a label that degrades rapidly once exposed such that repeated scanning of the same ID code cannot be performed. For example, using a photosensitive paper for the initial printing of a code that is then covered with an opaque peelable cover provides for a unique ID code that can be read but after peeling off the cover the photosensitive paper will darken destroying the readability of the unique ID code. In other embodiments of the invention the unique ID code be erased during the reading process, for example, a magnetic code may be disrupted by a read head that is followed by a strong magnet. An optically machine read code may be erased by subsequent or concurrent exposure of the label during the reading process to ultraviolet light, for example, which photobleaches the printed code.

Within embodiments of the invention the machine readable code may be imprinted upon the first part of a label which is intended to remain attached to the product and to be revealed by removal of a second part of the label which rendered the machine readable code unreadable prior to its removal.

Within embodiments of the invention the machine readable code is imprinted upon the first part of a label which is intended to be removed from the product thereby revealing the code, wherein a second part of the label remains attached to the product and the machine readable code unreadable prior to its removal.

Within embodiments of the invention the machine readable code is imprinted upon the first part of the label which is intended to be removed from the product thereby revealing the code, wherein the machine readable code is unreadable prior to its removal.

Within embodiments of the invention the machine readable code is formed in conjunction with a two-part label wherein the removal of a first part of the label renders the machine readable code visible upon either the first part or a second part that remains attached to the product. For example, laser cutting of a label may yield a label that has, for example, a bar code inscribed into the paper such that when the label is removed from the product the adhesive is sufficiently strong to retain portions of the label whilst others having any or increased physical integrity to the removed portion are removed.

In other embodiments of the invention the removal of a second peelable portion of the label results in the rupturing of micro-beads or micro-capsules of a chemical or chemicals that render the machine readable code readable or degrade the machine readable code over a short period of time such that it is rendered unreadable or corrupted and invalid.

Within other embodiments of the invention the unique ID code may be verifiable until the unique ID code is associated with a transaction wherein the unique ID code is “used” and now will, upon a verification request, return a non-verified response and/or a response denoting verification failed as product already sold for example.

As described supra in respect of the exemplary process flows described and depicted in respect of FIGS. 4 to 13 according to embodiments of the invention the manufacturer may initially request a batch of unique IDs to associated with a batch of products manufactured wherein the remote services associate the manufacturer, product, and potentially other information to the unique IDs generate. Accordingly, when the unique product ID code is subsequently scanned the ULSAPs according to embodiments of the invention may return data in addition to whether the code is valid including the product it was associated with and the manufacturer. Accordingly, if a counterfeiter is lucky enough to establish through a process of random generation an ID matching an issued legitimate unique lD code then they must further stretch their luck by associating it with the correct product as the unique ID code may trigger a verification including details of the product. Optionally, a product may be sold within a store with no UPC code as the scanning process triggers communication to the remote servers that based upon the unique ID code return the product short form description for inclusion upon the PoS transaction receipt, an image of the associated product (for rapid user verification) and its UPC code which is then cross-referenced to the retailer's PoS databases to establish the current pricing data for the product.

As described supra in respect of the exemplary process flows described and depicted in respect of FIGS. 4 to 13 according to embodiments of the invention when the user scans a unique ID code they are provided with verification data relating to the product. In other embodiments of the invention the user register with a ULSAP and scan a unique ID associated with their product and be provided additional information from the manufacturer. Alternatively, the manufacturer may also have the ability to attach additional information to a single ID or a group of IDs either at their creation or at a subsequent point in time. This information may be made available to anyone subsequently performing a process relating to the unique ID(s) affected or to a predetermined subset. For example, a manufacturer may add a recall notice to a product and hence a range of IDs, a shipper may tag a shipping ID and hence the range of product IDs associated with the shipping ID as being stolen, the manufacturer may add a context to a hatch of unique IDs and winners are established based upon purchasing the items marked as winners without any indication that the product(s) are winners being evident to the supply chain, or other information aiding identification of a genuine product may be added. Where the user registers the product through a service associated with the ULSAP then such information could then be passed to the user subsequently rather than at the time of purchase.

As a unique IDs may be associated with elements of a shipment process then palletizing a delivery rather than simply stacking, for example. 100 Nike trainer boxes becomes stacking 100 Nike scanned trainer boxes so that the shipment pallet is associated with a unique ID so that its progress/location etc. are known through the supply chain. At a distribution depot this means that pallets for different stores can be specifically created, logged and tracked. Hence, a scanned unique ID code associated with a shipment to a retailer in San Francisco and established as stolen is now being logged as scanned from Buffalo, N.Y. Thereby precise information to authorities may be given in such events.

As described supra in respect of the exemplary process flows described and depicted in respect of FIGS. 4 to 14 according to embodiments of the invention when an end-user (customer) scans a unique ID code associated with a discrete item of product then embodiments of the invention may respond with different responses including the following processes of fake, stolen, first look-up, subsequent look-up

Fake: If the unique ID was not found during the database look up processes by the ULSAP then the ULSAP may respond indicating that the product was not located in its database thereby indicating a non-genuine product. The response may also include other information relating about whom to contact, i.e. the ULSAP with image/details of the product and/or product manufacturer to report the non-genuine item.

Stolen: If a code has been associated with a product or batch or products that have been reported stolen then the database lookup processes by the ULSAP may respond indicating that the product was located in the database thereby indicating it as a genuine product but that it has been identified as stolen. The response may include other information relating about whom to contact, i.e. the ULSAP with image/details of the product and/or the location, retailer, etc. of the seller to report the stolen genuine item.

First Look-Up: If the unique ID is found during the database look up processes by the ULSAP and it is the first time (or predefined number of times) that the unique II) has been scanned then the ULSAP responds indicating the product is genuine. This may include, but not be limited to, a description of the product associated with the unique ID scanned, an image of the product, and its manufacturer. Additional information may also be displayed and/or the unique ID records stored on the ULSAP updated to include, for example, the network address of the system scanning the unique ID code, date/time of the scan and/or other information made available to it such as user for example.

At this point the user may be provided means to record that the product belongs to them, e.g. providing their name and/or email address, in a process comparable to “registering” the product. Such a process may for example allow the subsequent transfer of the registration to another user at a subsequent time and/or allow the registered user to be notified of any recall etc. as well as allow the user to track their purchases for accounting, warranty, insurance purposes, or any number of other reasons.

Subsequent Look-Up: If the unique ID is found during the database look up processes by the ULSAP and it is not the first time (or predefined number of times) that the unique ID has been scanned then the ULSAP responds indicating that the product has been previously scanned or scanned more than the predefined times and the ULSAP may provide information about who to contact, i.e. the real product manufacturer to report the non-genuine item to, and may also provide additional information such as discussed above in respect of an initial first look-up.

At this point, within some embodiments of the invention, the process may proceed according to sub-process A or B as outlined below.

Sub-Process A: If data relating to the user and/or the network address and/or other information stored within the ULSAP matches information that relating to the current scan then the ULSAP responds that the unique ID has been invalidated, identifies that the product may be genuine. The ULSAP may also return the description of the product and provide information that the user and/or network address and/or other information from the previous scan(s), matches information provided in the current scan. This information may aid the user in determining whether the product is genuine or not.

Sub-Process B: If there is not enough matching information relating to current scan and previously stored data relating such as described in Sub-Process A then the ULSAP returns the description of the product, and that the ULSAP cannot guarantee that the currently scanned product is genuine. For example, a counterfeiter may have copied the same code to multiple identical products which have been previously scanned The ULSAP may return information about when it was invalidated, for example, the date/time and/or network address and/or other information that was made available to the ULSAP, such as in Sub-Process A. Typically, user identification information etc. would be anonymized to initials only, for example.

The ULSAP may, in some embodiments of the invention, contain functionality to allow the user to remain relatively anonymous, perhaps only an e-mail address, or alphanumeric identifier, or provide full user contact information such as mailing address, phone numbers etc. The user may also be able to determine which manufacturer contacts it wants to be notified of.

The ULSAP may, in some embodiments of the invention, also contain functionally that allows for a user, typically a consumer, to transfer his product registration to another party, should the product be re-sold by the user. This allows the genuine chain of custody to remain with the product.

The ULSAP may, in some embodiments of the invention, contain functionally that allow for the manufacturer to issue recalls, carry out promotions (i.e. rebates, coupons etc.) relating to specific products and/or unique IDs and notify the user.

The ULSAP may, in some embodiments of the invention, contain functionality that allows the manufacturer to reset IDs so that previous scans are erased, this functionality will require additional verification to ensure that the request is authorized.

The ULSAP may, in some embodiments of the invention, contain functionality to limit how many unique ID scans are performed per given time period and/or per user and/or per network address to limit hacking where users are trying to “guess” IDs and/or establish coding generator data to generate unique IDs.

The ULSAP may, in some embodiments of the invention, allow a manufacturer to perform statistics on ID's, including which ones where scanned, date-time statistics, and or location statistics based on network address, etc. or any other content stored by the ULSAP.

The ULSAP may, in some embodiments of the invention, provide access to inter-relationships between unique II)s, such as one unique ID being associated with a collection of other IDs for reporting purposes, for the purposes of providing customs information, retailer reporting, logistics, etc.

As described supra in respect of the exemplary process flows described and depicted in respect of FIGS. 4 to 14 according to embodiments of the invention there is now presented a simple exemplary usage scenario. Accordingly, consider a fictitious manufacturer, referred to as “BuildIt”, who manufactures a fictitious product entitled “Widget”, and a fictitious ULSAP referred to as “AuthenTICK” which has implemented an embodiment of the invention and offers a software application “AuthenTICK Verifier” to users.

BuildIt establishes a manufacturing lot/batch for its Widget which has a manufacturing quantity of 10,000. In this instance Buildit also palettes and/containerizes product for shipment from one jurisdiction to another rather than using any third party service provider. Based upon its known packaging, palletization and containerization processing then BuildIt also knows that for 10,000 Widget products there will be 1,000 pallets of boxed product which will be shipped in 10 containers. Accordingly, BuildIt requests issuance of the following unique IDs by AuthenTICK:

10,000 unique product IDs,

10,000 unique package IDs;

1,000 unique pallet IDs;

20 unique IDs for customs; and

20 unique IDs for distributors.

In requesting each set of unique IDs it requires that the unique ID in addition to the unique content portion includes the name of the product, e.g. Widget, and that they also contain lot codes “ABCJanuary2015.” AuthenTICK, then transmits to BuildIt the requested codes in QR format which are Version 4 33×33 QR codes containing up to 50 characters with Level Q error correction. BuildIt then prints 10,000 product labels each comprising one of the unique product IDs and 10,000 package labels each comprising one of the unique package IDs.

During manufacturing BuildIt places one of the 10,000 product labels onto each Widget it manufactures. It is expected that the end-user that scans these product labels with the unique product ID will be the end-user of the WIDGET and that this unique product ID allows them to verify through the AuthenTICK verifier that the Widget they have purchased is genuine. Each Widget product is then packaged into the customer level packaging, e.g. cardboard box, onto which one of the 10,000 packaging labels have been attached. At this point the manufacturer associates each unique product ID to a unique package ID and may also associate other information such as date/time of manufacture, manufacturing line, and manufacturing personnel data.

Subsequently, within its operations batches of 10 products are assembled for palletization. Each pallet is anticipated as being delivered to a single retail location. Accordingly, as the 10 products are assembled, loaded onto the pallet and wrapped a pallet label is attached which includes one the unique pallet IDs on the wrapped pallet containing the 10 products for sale. In this process Huila associates within the AuthenTICK USLAP the association of which 10 products are grouped for a particular pallet. This process by virtue of not being a verification step docs not invalidate the product and/or pallet IDs unless one of the product codes and/or pallet code is not valid in which instance the AuthenTICK USLAP invalidates the entire group. In this manner a counterfeiter cannot introduce a quantity of counterfeit product within a delivery including legitimate product.

It is expected in this instance that the end-user exploiting the unique pallet ID be a retailer verifying the product as genuine before it is unpacked for sale to the customer. However, it would be evident that an intermediate distribution chain element may also verify the inventory using the unique pallet ID. In this instance, where the manufacturer BuildIt knows the identities and locations of the distribution warehouses then the AuthenTICK ULSAP may not invalidate the unique pallet ID where the request is made from a location/network associated with the known distribution warehouse to whom the pallet is routed. In this manner, a pallet at the incorrect warehouse invalidates the unique pallet fD for subsequent use but a correct warehouse does not. Optionally, the geolocation information may not be employed and the validation/invalidation is based upon credentials and verification of the distributor.

Subsequently, the 1,000 pallets comprising 10,000 products are containerized for shipment to Europe, United States and Canada from BuildIt's manufacturing operations in Taiwan, for example. In assembling the 1,000 pallets into the 20 containers then each container is labelled using one of the unique IDs for customs and one of the unique IDs for distributors. As with previous steps the AuthenTICK USLAP is provided the 50 pallet IDs that are loaded into each of the 20 containers. It is expected that the end-users of the ID's are customs agents, who employ the unique customs ID when the container is clearing customs, and the port of entry distributor, who employ the unique ID for distributors. In each case the use of the appropriate code verifies the container as originating with respect to BuildIt and exactly what is within the container. In this instance, customs may be provided, for each container, the 50 unique pallet IDs allowing them to verify that these are genuine and that no pallet not part of the manufacturer's process has been inserted into the customs clearance process. Similarly, the distributor may do the same.

Accordingly, each level of the supply chain from manufacturer through shippers, customer, etc. to end-user can be assured that they are dealing with genuine product from BuildIt by using the appropriate unique fD code for their level in the process. It would be evident to one of skill in the art that additional levels of codes can be inserted/removed depending on the product, and or distribution of that product from the physical manufacturing of the product down to the consumer ownership of the product. If a counterfeiter seeks to “copy” the product, or the codes, then their scanning and verification processes with the USLAP will alert the end-user at that level in the process either that the codes does not exist or that the code exists but has previously been scanned more than a predetermined number of times and to be suspicious of a counterfeit product. In other instances, a geolocation mismatch or other data mismatch even with a valid ID code may be sufficient for the USLAP to denote the product(s) counterfeit.

It would be evident that the product being protected does not have to a high value product but it can equally be a low/medium value product and/or a common commodity type product. As such whilst it may be considered appropriate for electronics, PEDs, FEDs, etc. it would also be evident that essentially any product and/or item that can be labelled in one form or another can be tracked and verified. For example, such products/items may include, but not be limited to, prescription drugs, non-prescription drugs, pre-packaged foods, clothing, food, cosmetics, alcohol, controlled substances, tobacco products, footwear, automotive parts, replacement and/or spare parts, consumable items, and pharmacy products.

Within embodiments of the invention where the unique ID code is associated with a “best before”, “use before”, “expiry” of “best use date” then the scanning of the unique ID at a PoS, for example, may trigger a response from the ULSAP that the item is a valid product from the manufacturer but the current date/time is after the identified expiry date. Alternatively, where products have aspects of their distribution, sale, use, etc. that are jurisdictional then the geolocation information may identify that the product is valid but contravenes a jurisdictional issue.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD. If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
generating a unique product identity comprising:
receiving a first request at a server from a manufacturer for a set of B unique identities for attachment to a batch of products, the request identifying at least the manufacturer, product related data, and the batch size B;
generating at the server a set of B unique codes according to a predetermined standard;
generating at the server the set of B unique identities, each unique product identity formatted according to a predetermined first machine readable format and incorporating at least one of the unique codes;
transmitting the set of B unique identities to the manufacturer for marking the batch of products; and
storing the data relating to the request within a database such that the database comprises product identification data relating to valid requests; and
receiving a verification request comprising:
receiving a second request at the server from a remote electronic device connected to the server via a network, wherein the remote electronic device incorporates at least a microprocessor and a reader supporting at least the predetermined first machine readable format and the request includes a code read from a product by the reader;
determining whether the code received includes a product identity matching a unique product identity stored within the database; and
in dependence upon at least the determination sending a response to the remote electronic device.

2. The method according to claim 1 further comprising;
generating at least one unique shipment identity of a plurality of unique shipment identities, each unique shipment identity of the plurality of unique shipment identities generated by the server in response to a shipment request received from an electronic device associated with a shipper and comprising first data relating to the shipment and second data relating to the unique product identities of products within the shipment; and
wherein determining whether the code received includes a unique product identity matching a unique product identity stored within the database further comprises determining whether the verification request was received from the remote electronic device within a jurisdiction consistent with the first data relating to the shipment.

3. The method according to claim 1, wherein
upon a positive determination the response includes at least an indication of the positive match and an identity of the product relating to the matched unique product identity.

4. The method according to claim 1, further comprising;
upon determining the code received includes a product identity matching a unique product identity stored within the database adjusting a counter associated with the unique product identity within the database; and
establishing the determination as failing if the counter associated with the unique product identity within the database has met a predetermined threshold.

5. The method according to claim 1, wherein
determining whether the code received includes a product identity matching a unique product identity stored within the database further includes determining if product identity data received with the verification request matches the product data stored within the database in association with the unique product identity received with the first request from the manufacturer to generate the unique product identity.

6. A method of verifying the authenticity of a product comprising:
receiving secure requests from manufacturer identifying first products to be manufactured;
providing the manufacturers with first machine readable codes for attachment to the first products, each the first machine readable code comprising at least a unique identity and stored within a database upon issuance;
receiving a request to verify the authenticity of a second product incorporating at least a scanned second machine readable code attached to the second product;
comparing a code within the second machine readable code with the first machine readable codes within the database;
determining whether to send a first message or a second message in dependence upon the comparison, wherein
the first message comprises at least an indication that the second product has failed authenticity verification; and
the second message comprises at least an indication that the second product has passed authenticity verification and an identity of the product relating to the matched unique product identity.

7. A method of verifying the authenticity of a product comprising:
providing a machine readable code at least one of as part of or attached to a product, the machine readable code encoding at least a unique identity issued by a verification authority allowing subsequent authenticity verification to be performed by scanning and transmitting the machine readable code to the verification authority, wherein the unique identity is not associated with any aspect of the product and its manufacturer except that it was generated next in sequence by a unique identity generator forming part of the verification authority in response to a request for a batch of machine readable codes from the manufacturer.

8. The method according to claim 7, wherein
at least one of
the machine readable code is imprinted upon a first part of a label which is intended to remain attached to the product and to be revealed by removal of a second part of the label which rendered the machine readable code unreadable prior to its removal;
the machine readable code is imprinted upon a first part of a label which is intended to be removed from the product thereby revealing the code, wherein the second part of the label remains attached to the product and the machine readable code unreadable prior to its removal;
the machine readable code is imprinted upon a label which is intended to be removed from the product thereby revealing the code, wherein the machine readable code is unreadable prior to its removal.

9. The method according to claim 7, wherein
the machine readable code is imprinted onto a label and is subsequently rendered invisible after a predetermined period of time by at least one a reaction triggered upon removal of a portion of the label to render the machine readable code readable and scanning of the machine readable code at a point of sale terminal.

10. A label comprising;
a first part comprising at least a machine readable code encoding at least a unique identity issued by a verification authority allowing subsequent authenticity verification to be performed by scanning and transmitting the machine readable code to the verification authority, wherein the unique identity is not associated with any aspect of the product and its manufacturer except that it was generated next in sequence by a unique identity generator forming part of the verification authority in response to a request for a batch of machine readable codes from the manufacturer.

11. The method according to claim 10, wherein
at least one of:
the machine readable code is imprinted upon the first part of the label which is intended to remain attached to the product and to be revealed by removal of a second part of the label which rendered the machine readable code unreadable prior to its removal;
the machine readable code is imprinted upon the first part of the label which is intended to be removed from the product thereby revealing the code, wherein a second part of the label remains attached to the product and the machine readable code unreadable prior to its removal;
the machine readable code is imprinted upon the first part of the label which is intended to be removed from the product thereby revealing the code, wherein the machine readable code is unreadable prior to its removal.

12. The method according to claim 10, wherein
the machine readable code is imprinted onto a label and is subsequently rendered invisible after a predetermined period of time by at least one a reaction triggered upon removal of a portion of the label to render the machine readable code readable and scanning of the machine readable code at a point of sale terminal.
